(19) United States
(12) Patent Application Publication
(10) Pub. No.: US 2023/0160852 A1
(43) Pub. Date: May 25, 2023

(54) ELECTROPHORESIS DEVICE FOR USE IN AN ELECTROCLEARING METHOD

(71) Applicant: MobiCron GmbH, Göttingen (DE)

(72) Inventors: Fred S. Wouters-Bunt, Göttingen (DE); Geertruida Bunt, Göttingen (DE); Jörg Ronnenberg, Göttingen (DE); Maren Fräger, Immenhausen (DE); Stephan Diekmann, Diessen (DE)

(21) Appl. No.: 17/916,220

(22) PCT Filed: Mar. 24, 2021
(86) PCT No.: PCT/EP2021/057619

§ 371 Date: Sep. 30, 2022

(30) Foreign Application Priority Data
Apr. 1, 2020 (DE) 10 2020 109 087.0

(51) Int. Cl. G01N 27/447; G01N 27/333; G01N 1/40; G01N 35/00

(52) U.S. Cl. CPC G01N 27/44743; G01N 27/333; G01N 1/40; G01N 35/00009; G01N 2001/4038; G01N 2035/00019; G01N 2035/00306

(57) ABSTRACT

The invention relates to an electrophoresis device (1) for use in a method for producing transparent biological samples (2), comprising a reaction frame (3), the reaction frame (3) having an open top side (4) and a bottom side (5) opposite the top side (4), characterized in that the bottom side (5) has at least partially one opening (6). The invention also relates to a use of a sample cassette (19) for an electrophoresis method.

### CROSS-REFERENCE TO RELATED APPLICATIONS

This is the United States National Phase of International Patent Application No. PCT/EP2021/057619, filed Mar. 24, 2021, which claims priority to German Application No. DE 10 2020 109 087.0, filed Apr. 1, 2020, the entire contents of each of which incorporated by reference herein.

### FIELD OF THE DISCLOSURE

The invention relates to an electrophoresis device for use in a method for producing transparent biological samples.

### BACKGROUND

Transparent biological samples (hereinafter also referred to as “preparations”, “tissue” or the like) are required in pathology and histology to enable the prepared tissue to be imaged, for example in three dimensions, for instance by means of light sheet microscopy. In order to achieve sufficient transparency of the preparations for this purpose, those components that have a high absorption or that have a refractive index that differs from the refractive index of the tissue to be examined must be removed from the preparation. These components primarily include the heme groups of the blood pigment hemoglobin, as well as lipids from the biological tissues. The process of removing non-transparent substances and components from a tissue is referred to and known as clarifying or clarification (also known as “clearing”). Some of the methods of electrophoresis are used for this purpose; this procedure is then also referred to as “electroclearing”.

In conventional electrophoresis, the components (analytes) to be examined are separated according to their size or charge within the solid phase of a suitable carrier material and thus detected, the conductivity of the electrophoresis buffer being substantially determined by the ions previously dissolved in the buffer. The buffer (also referred to as the “reaction liquid”) has a high ionic strength. A contamination of the buffer by the analytes and a consequent change in the electric field does not usually occur in this case.

In contrast, known from DE 10 2016 123 458 B3 is a preparative electrophoresis method for clarification of tissue preparations in which the electrophoresis buffer has a low ionic strength. Here, the solid phase is the tissue from which the “contaminating” components are to be removed under the action of an electric field. In this case, positively charged ions migrate to the cathode, negatively charged ions to the anode. During their release from the tissue, the ions substantially determine the conductivity of the electrophoretic buffer. The clearing process can be followed quantitatively on the basis of the change in the conductivity of the buffer during electrophoresis. In order to allow the largest possible proportion of the electrophoretic force to act on the interfering components, or components to be removed, the ion concentration of the buffer must be appropriately low and kept constant. A low ion concentration also minimizes the flow of current and thus the heat generated, thereby making it possible to avoid thermal damage to the tissue.

Also known from the DE 10 2016 123 458 B3 is an electrophoresis chamber having a waisted reaction chamber that is rotationally symmetrical about a vertical axis and that can be filled with electrophoresis solution, and having a downwardly open annular channel into the reaction chamber, a first annular electrode in the reaction chamber and a second annular electrode in the reaction chamber above the waist. For the corresponding electrophoresis method, the ion concentration of the buffer must be appropriately low and kept constant. During the clarifying process, therefore, the contaminated electrode buffer must be exchanged for a new, non-contaminated buffer. The buffer is exchanged in this case by tipping the old buffer out of the reaction chamber, which is open at the top, and then admitting fresh buffer. This can damage the tissue, which is often very sensitive to mechanical effects, for which reason it should be removed from the reaction frame before every buffer change. However, unwanted impairment of the tissue quality can also occur during the step of removing the sample. In addition, this additional work step is time-consuming.

### General Description

The invention is therefore based on the object of providing an electrophoresis device, for use in a method for producing transparent biological samples, that eliminates the disadvantages in the prior art and that above all enables the reaction liquid to be changed quickly and easily. The electrophoresis device provided is intended in this case, in particular, to ensure a changing of the reaction liquid that is as gentle as possible for the biological sample.

To achieve the object, the invention provides an electrophoresis device for use in a method for producing transparent biological samples, comprising a reaction frame, wherein the reaction frame has an open top side and a bottom side opposite the open top side. The device is characterized in that the bottom side at least partially comprises an opening. A reaction frame is preferably provided, the bottom side of which is designed entirely as an opening. Such a reaction frame therefore has no base part connected to the reaction frame. The top side of the reaction frame in this case is to be understood as the side that is arranged above a horizontal central axis of the reaction frame. Accordingly, the bottom side is arranged below the horizontal central axis of the reaction frame.

An electrophoresis device designed in this way is advantageous for the clearing method because the reaction liquid required for the method can be exchanged quickly and easily. For this purpose, it may be provided, for example, that the reaction frame is received in a receiving vessel filled with reaction liquid, or buffer, for which purpose the receiving vessel must have a base plate. The receiving vessel in this case may be, for example, a tank or a hollow cylinder. The reaction frame let into the receiving vessel initially forms, with the base plate of the receiving vessel, a reaction chamber that is open on one side, the open side being the top of the reaction frame, i.e. the side opposite the base plate. The bottom side of the reaction frame is then the side that faces toward the base plate of the receiving vessel. Accordingly, the top side of the frame is the side that is directed away from the base plate of the receiving vessel. It is also conceivable for the reaction frame to have a lattice or mesh structure in the region of an opening on the base plate.

The reaction frame can be removed from the receiving vessel at any time and transferred to another receiving vessel filled with fresh reaction liquid, without transferring large amounts of the contaminated reaction liquid. The old reaction liquid can then drain off through the opening in the bottom side of the frame. Such a modular construction of the device, comprising a reaction frame and a receiving vessel, enables a buffer to be changed easily. In particular, the device does not have to be tipped for changing the buffer.

The reaction frame may have a cover plate, which is fixedly or detachably connected to the top side of the reaction frame, wherein the cover plate may substantially completely cover the top side of the reaction frame and of the receiving vessel. A detachable connection may be achieved, for instance, by a plug connection. As soon as the cover plate covers the reaction frame and possibly the receiving vessel, the reaction chamber is completely closed. This prevents foreign bodies from entering the reaction chamber, or users of the device from being able to come into contact with the buffer during the electrophoresis.

According to a particular design, a horizontal reaction frame is provided. The horizontal reaction frame comprises four inner side walls, which are arranged in a cuboid shape in relation to one another. In this case, a corresponding receiving vessel may be provided, having four outer side walls that are likewise arranged in a cuboid shape in relation to one another. The inner side walls may each be of the same length or comprise two long and second short side walls. Correspondingly, the reaction frame may have a square or a rectangular shape. The same applies analogously to the outer side walls and to the receiving vessel. In the case of such an embodiment, the four outer side walls of the receiving vessel must have a common inner circumference that is larger than a common outer circumference of the inner side walls of the reaction frame. The inner and the outer side walls may each be glued to one another or plugged into one another. The outer side walls of the receiving vessel should be of a height that is at least half the height of the inner side walls of the reaction frame. Preferred, however, is an embodiment in which the outer side walls of the receiving vessel are at least as high as the inner side walls of the reaction frame. In addition, there should be a sufficiently large distance between the outer side walls of the receiving vessel and the inner side walls of the reaction frame such that the frame can be inserted into and removed from the tank quickly and easily. This distance should preferably be at least 0.5 cm.

A vertical embodiment may also be provided, which is characterized in that the reaction frame comprises an inner hollow cylinder. A corresponding receiving vessel is designed as an outer hollow cylinder, wherein the outer hollow cylinder of the receiving vessel has an inner circumference that is larger than an outer circumference of the inner hollow cylinder of the reaction frame. The outer hollow cylinder of the receiving vessel should be of a height that is at least half the height of the inner hollow cylinder of the reaction frame. Preferred, however, is an embodiment in which the outer hollow cylinder of the receiving vessel is at least as high as the inner hollow cylinder of the reaction frame. In addition, there should be a sufficiently large concentric distance between the inner and the outer hollow cylinder such that the frame can be inserted into and removed from the receiving vessel quickly and easily. This distance should preferably be at least 0.5 cm.

According to a preferred design, it is provided that the electrophoresis device has a first electrode and a second electrode. The first and the second electrode can be connected to a voltage source in order to generate an electric field. The biological tissue in this case is arranged substantially in the center of the reaction chamber because an approximately homogeneous electric field is concentrated there, between the electrodes arranged opposite one another. In particular, it is provided in this case that the first electrode and the second electrode are each realized as plate electrodes or as a grid electrode. Electrodes designed in this way have the advantage that the electric field is evenly distributed over the entire reaction chamber and is not just limited to a particular region within the reaction liquid. However, other electrode shapes are also conceivable, such as, for example, zigzag electrodes. It is also advantageous if the first electrode and the second electrode are in electrical contact with the power source, each via an electric leadthrough. The electric leadthroughs make it particularly easy to connect the electrodes to a voltage device.

It may be provided in this case that the electric contacts for connecting the leadthroughs to the power source are recessed into the cover plate of the reaction frame, such that the cover plate needs to be attached to, or placed on, the reaction frame in order to connect the device to the power source. In this case, the electric contacts can simultaneously serve as plug connections for fixing the cover to the reaction frame. This ensures that current can only flow in the reaction chamber when the cover is connected to the reaction frame, i.e. if there is a closed reaction chamber.

According to the horizontal embodiment, it is also provided that the first electrode is arranged, on the reaction chamber side, on one of the inner side walls of the reaction frame, and that the second electrode is arranged, on the reaction chamber side, on the inner side wall that is opposite the first electrode. The two electrodes should be arranged in parallel and lie in the same horizontal central axis. Such an arrangement of the electrodes results in a current flow in the horizontal direction. The sample in this case should be arranged between the electrodes.

According to the vertical embodiment, the first electrode should be arranged, on the reaction chamber side, on the cover plate of the reaction frame, and the second electrode should be arranged, on the reaction chamber side, on the base plate of the receiving vessel. The two electrodes in this case should lie in the same vertical central axis. Such an arrangement of the electrodes results in a current flow in the vertical direction. The sample in this case should be arranged between the electrodes.

It may also be provided that the electrophoresis device comprises a sample cassette in which the sample is fastened and with which the sample can be arranged in the reaction chamber, between the electrodes.

The sample cassette in this case may be standardized. The use of the sample cassettes according to the invention facilitates the execution of electrophoresis methods. It is possible, for example, for each cassette to have a bar code and/or color code by means of which the cassettes can be identified. Such a coding has the additional advantage that it indicates the orientation of the sample cassette relative to the direction of electrophoresis. In this way, when the sample cassette is changed to another receiving vessel, it can easily be inserted in the correct electrophoresis direction. Moreover, a cassette holder, into which the sample cassette can be clamped, may also be provided.

According to a preferred design, it is provided that the sample cassette comprises a base element and a cover element, which can be plugged together to form a cassette enclosing the sample, wherein the base element and the cover element are pivotably connected to one another, in particular via a flexible connection (for example a hinge). According to a preferred embodiment, it is provided that the sample cassette, or the cassette, is perforated, at least in sections, wherein in particular the base element and the cover element each have a multiplicity of perforations arranged in a grid-like manner. The perforations allow buffer to reach the tissue sample, which in turn ensures that the electric current can remove the desired substances from the sample. Such sample cassettes are particularly suitable for use in a clearing method because they can be easily standardized.

It may further be provided that the reaction frame has at least one receiving profile for receiving the sample cassette (or for receiving the cassette holder). According to the horizontal design of the device, grooves are provided for this purpose, which are each realized, on the reaction chamber side, on two opposite inner side walls and extend in the vertical direction. Advantageously, the at least one receiving profile may also comprise a horizontally realized groove, which is realized, on the reaction chamber side, in the base plate of the receiving vessel. According to this solution, the sample cassette can be inserted into the grooves by being slid-in in the vertical direction. A receiver realized in this way has the advantage that the sample cassette can be easily and reliably introduced into the receiver. Furthermore, as a result of this construction, the reaction chamber is divided into a first reaction compartment and a second reaction compartment when the sample cassette or the cassette holder is received in the receiving profile. In order that the sample cassette or the cassette holder can divide the reaction chamber into two reaction compartments, the sample cassette or the cassette holder is realized in such a manner that they each protrude above the surface of the reaction liquid when they are received in the receiving profile of the chamber. This ensures that the current that flows between the electrodes during the electrophoretic clearing method passes exclusively through the sample cassette, or the cassette holder, and in particular through the tissue sample.

According to an advantageous development, it is also provided, in the case of the horizontal embodiment of the electrophoresis device, that the receiving profile is arranged along a vertical central axis. It is also possible for the sample cassette and the receiving profile to be realized in such a manner that the biological sample is oriented substantially perpendicularly to the horizontal central axis, and thus parallel to the electrodes, when the sample cassette is received directly in the receiving profile. Correspondingly, the cassette holder should also be realized in such a manner that the biological sample is oriented substantially perpendicularly to the horizontal central axis when the cassette holder is received in the receiving profile. This allows the biological sample to be arranged in the reaction chamber where an approximately homogeneous electric field is concentrated between the electrodes. It is also conceivable that a buffer change can be performed in the reaction chamber by removing the sample cassette from the electrophoresis device in an upward direction and inserting it into a reaction chamber filled with fresh, or new, buffer. This can also simplify the changing of the buffer. The receiving profile should preferably have a locking mechanism by which the sample cassette, or the cassette holder, can be locked at a particular position relative to the reaction frame. This mechanism may be, for example, a tapering of the at least one groove in the direction of the bottom side of the reaction frame, which prevents the sample cassette, or the cassette holder, from sliding downward, i.e. in the direction of the bottom side, through the receiving profile of the reaction frame. The locking mechanism enables the reaction frame to be transferred quickly and safely from one receiving vessel to another without the risk of loss of the sample cassette, or the cassette holder.

According to the vertical embodiment, it may be provided that the receiving profile is an annular support, which is arranged, on the reaction chamber side, on the inner hollow cylinder and in which the sample cassette (or the cassette holder) is received. The reaction chamber in this case is divided into a first reaction compartment and a second reaction compartment when the sample cassette, or the cassette holder, is received in the receiving profile. To perform vertical electrophoresis, provision may also be made for the cassette holder or the receiving profile to have at least one vent hole that connects the two reaction compartments. The vent hole serves, when the reaction chamber is filled with buffer, to discharge upwardly gas or air bubbles produced in the lower part. The vent hole allows these bubbles to pass through so that they can reach the surface unhindered. In addition, the receiving profile may be inclined relative to the horizontal central axis. The inclination has the advantage that the cassette holder, or the sample cassette, can also be received with an inclination relative to the horizontal central axis. It is also conceivable in this case for the vent hole to be realized at the highest point of the cassette holder, or of the receiving profile, the highest point being understood to be that region of the cassette holder or the receiving profile that is closest to the surface of the reaction liquid. In this way, advantageously, the gas bubbles produced when the lower reaction chamber is filled collect in the vicinity of the vent hole, through which they can then be discharged toward the surface of the reaction liquid.

It may additionally be provided that the inner and outer side walls and the base plate are made from a chemically inert and electrically insulating material, in particular from glass or plastic. It is conceivable, for example, for the receiving vessel and the frame to be made of acrylic glass. The sample cassette and the cassette holder are also preferably made from a chemically inert and electrically insulating material, the sample cassette and the cassette holder preferably being made from a plastic, particularly preferably from polyoxymethylene. This ensures that the current that flows between the electrodes during the electrophoretic clearing process passes exclusively through the tissue sample and not through the sample cassette or the cassette holder.

According to the vertically realized electrophoresis device, the receiving vessel comprises a base plate and an outer hollow cylinder. The reaction frame comprises an inner hollow cylinder. Both hollow cylinders in this case are rotationally symmetrical about a vertical central axis. The arrangement may be characterized in that the outer circumference of the inner hollow cylinder is smaller than the inner circumference of the outer hollow cylinder, thereby creating an annular gap between the inner hollow cylinder and the outer hollow cylinder when the reaction frame is received in the receiving vessel. Such an electrophoresis device can be produced and assembled quickly and easily, and is therefore particularly easy to use.

It may further be provided, according to one embodiment, that the inner hollow cylinder is connected to the cover plate and extends vertically in the direction of the base plate. The outer hollow cylinder extends vertically from the base plate in the direction of the cover plate, a first height of the inner hollow cylinder being less than a second height of the outer hollow cylinder, thereby forming a gap between the base plate and the end of the inner hollow cylinder on the base plate side.

It may be provided that the first electrode is attached to the reaction frame, starting from the central horizontal axis, in the direction of the cover plate in the upper chamber element, namely on the side of the inner hollow cylinder that faces toward the reaction chamber. The distance between the first electrode and the central horizontal axis in this case should be greater than the distance between the first electrode and the cover plate. The second electrode, on the other hand, may either be attached concentrically in the receiving vessel, on a side of the base plate that faces toward the reaction chamber, or on a side of the outer hollow cylinder that faces toward the reaction chamber, or on a side of the inner hollow cylinder that faces toward the outer hollow cylinder. In the last two cases, a gap should be formed between the end of the inner hollow cylinder on the base plate side and the base plate. This can be achieved by use of a cover plate to which the inner hollow cylinder is attached. The inner hollow cylinder then extends vertically in the direction of the base plate, and may be of a first height that is less than the second height of the outer hollow cylinder. It is provided in particular that the second (lower) electrode is arranged slightly above the gap. Gas bubbles produced at the second electrode during electrophoresis rise due to the arrangement of the lower electrode in the annular space between the outer and inner hollow cylinder, and do not collect under the sample cassette, or under the cassette holder. In order that the gas bubbles produced in this way can escape from the electrophoresis device, the outer hollow cylinder may have, for example, perforations in a region near the cover plate, via which the gas bubbles can be released to the external environment. It may further be provided that the cover plate does not touch the outer hollow cylinder, such that a small gap remains between the outer hollow cylinder and the cover plate when the cover plate rests on the inner hollow cylinder. The gas bubbles can then escape to the outside through this gap. The first electrode and the second electrode may each be of an annular shape. This ensures that the electric field is evenly distributed over the entire reaction chamber. In this embodiment of the reaction chamber, the sample and the electrodes are arranged substantially in the same vertical plane. A vertical electrophoresis device has the advantage that the sample cassette, together with the tissue sample, can be arranged horizontally.

It may be provided that the cover plate has a vertical pin for closing and opening the vent hole of the cassette holder, or of the receiving profile, the vertical pin passing through a corresponding hole in the cover plate such that it can be operated from outside the reaction chamber. The vertical pin is provided in particular to selectively open or close the vent hole, such that air bubbles that collect in the lower reaction chamber under the sample cassette or cassette holder when it is filled with reaction liquid can escape through the vent hole when it is open. After the reaction chambers have been completely filled with reaction liquid and the air bubbles have escaped, the vent hole is closed by means of the vertical pin.

The cover plate may advantageously have a through-hole for filling the reaction chamber with reaction liquid, the through-hole preferably being closable. In addition, it is conceivable for the through-hole to be recessed substantially centrally into the cover plate. The electrophoresis device can be easily filled with reaction liquid, or buffer, via the through-hole in the cover plate. The possibility of filling the two reaction compartments separately, i.e. separately from each other, with reaction liquid is particularly gentle on the sample.

In the case of the vertical design, a buffer change can be realized by removing the inner hollow cylinder of the reaction frame, together with the sample, from the outer hollow cylinder of the receiving vessel and inserting it into a second receiving vessel filled with unused buffer. The reaction liquid can then drain off through the opening in the bottom side of the cylindrical frame. In particular, this enables the buffer to be changed quickly during the clearing process. As a result of the exchanging of the reaction liquid, the originally low electric current, which has increased due to the elution of substances from the tissue, is reduced again to the low initial value. The point in time at which the buffer has to be exchanged is indicated by the power supply, according to the current-voltage characteristic.

A further embodiment provides that the first electrode has a first electric leadthrough for contacting to the power source, and that the second electrode has a second electric leadthrough for contacting to the power source. Advantageously, the first leadthrough to the power source may be arranged in the cover plate, and the second leadthrough in the cover plate or base plate.

It is additionally conceivable for the inner and the outer hollow cylinder and the base plate to be made from a chemically inert and electrically insulating material, in particular from glass or from a plastic (e.g. acrylic glass). It is further provided that the sample cassette and the cassette holder are made from a chemically inert and electrically insulating material, the sample cassette and the cassette holder preferably being made from a plastic, particularly preferably from polyoxymethylene. Finally, it is also conceivable for the sample cassette to be perforated, at least in sections, the base element and the cover element in particular each having a multiplicity of perforations arranged in a grid-like manner. This ensures that the current that flows between the electrodes during the electrophoretic clearing process passes through the tissue sample and not through the sample cassette or the cassette holder. A current flow past the sample, for instance through the reaction liquid or through sections of the sample cassette or the cassette holder, is to be avoided. It may further be provided that the sample cassette comprises a base element and a cover element that can be plugged together to form a cassette enclosing the sample, the base element and the cover element being pivotably connected to one another, in particular via a flexible connection or hinge.

### BRIEF DESCRIPTION OF THE FIGURES

Further features, details and advantages of the invention are given by the wording of the claims and by the following description of exemplary embodiments, with reference to the drawings.

FIG. 1 shows an electrophoresis device according to a horizontal embodiment, in a schematic plan view;

FIG. 2 shows an electrophoresis device according to a horizontal embodiment with a sample cassette and a receiving vessel, in a schematic plan view;

FIG. 3 shows an electrophoresis device according to a horizontal embodiment with a receiving vessel and a cover plate, in a longitudinal vertical cross-section;

FIG. 4 shows an electrophoresis device according to a horizontal embodiment with a receiving vessel and a cover plate, in a transverse vertical cross-section;

FIG. 5 shows an electrophoresis device according to a vertical embodiment, in a vertical cross-section;

FIG. 6 shows an electrophoresis device according to a further embodiment with a gap, in a vertical cross-section;

FIG. 7 shows an electrophoresis device according to a further vertical embodiment, in a vertical cross-section;

FIG. 8 shows an electrophoresis device according to a further vertical embodiment, in a vertical cross-section;

FIG. 9 shows a preferred embodiment of a sample cassette.

### DETAILED DESCRIPTION OF THE FIGURES

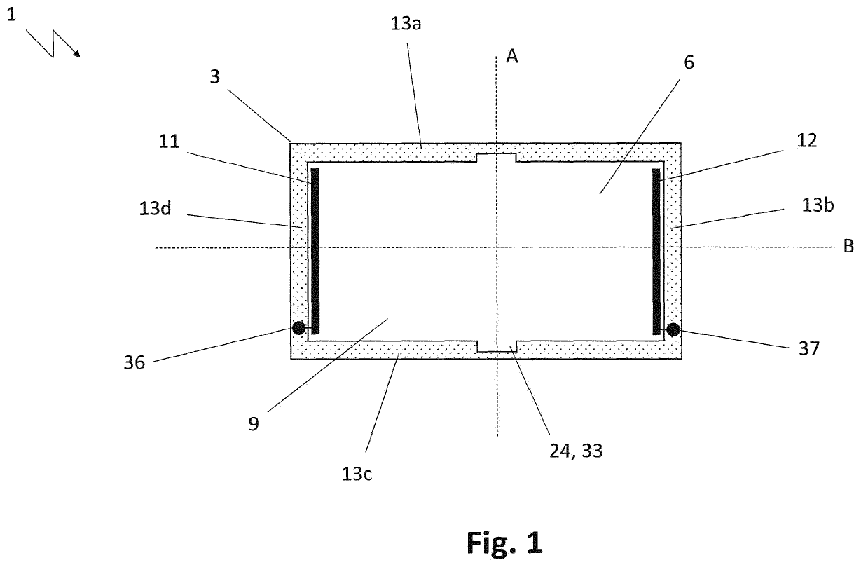

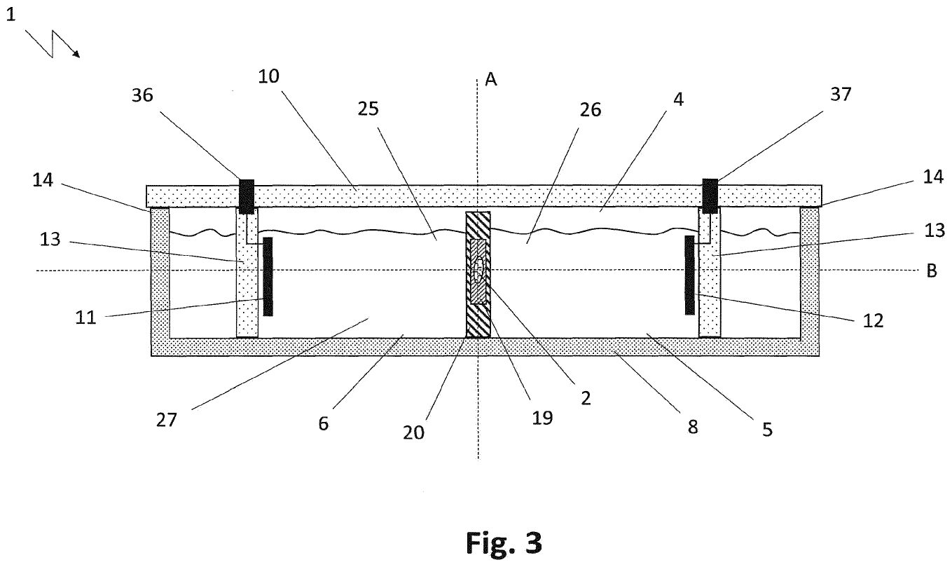

FIG. 1 shows an electrophoresis device 1 according to a horizontal embodiment, in a schematic plan view. The electrophoresis device 1 shown, which is intended for use in a method for producing transparent biological samples 2, preferably comprises a sample cassette (not shown) 19 as well as a reaction frame 3. The reaction frame 3 is made up of four inner side walls 13a-d, with the inner side walls 13a-d being connected to one another in such a manner that they form a cuboid that is open on two sides, and thus a reaction chamber 9 that is open on two sides. The reaction frame 3 is designed so as to be open on a top side 4 (FIG. 3) and on a bottom side 5 (FIG. 3). In this case the top side 4 of the reaction frame 3 is arranged above a horizontal central axis B (FIG. 3) of the reaction frame 3, whereas the bottom side 5 is arranged beneath the horizontal central axis B. In the case of the reaction frame 3 as shown in FIG. 1, the sample preparation 2 (not shown) and the electrodes 11, 12 are arranged substantially in the same horizontal plane. This allows the reaction liquid 27 to be changed easily. In particular, there is no need for the old reaction liquid 27 to be tipped out of the reaction frame 3. At the same time, the strength of the electric current can be influenced, for example by changing the buffer solution 27.

The reaction frame 3 shown in FIG. 1 has, in the reaction chamber 9, a first electrode 11 with a first electric leadthrough 36 for contacting to the power source, and a second electrode 12 with a second electric leadthrough 37 for contacting to the power source. The first and the second electrode 11, 12 can be connected to a DC voltage source via the electric leadthroughs 36, 37 in order to generate an electric field.

FIG. 1 additionally shows a receiving profile 24 in the form of grooves 33. The receiving profile 24 serves to receive the sample cassette 19 or to receive the cassette holder 20. According to the embodiment shown, the receiving profile 24 comprises grooves 33, which are each realized, on the reaction chamber side, on two opposite inner side walls 13a,c and extend substantially in the vertical direction.

It may be provided in this case that the grooves 33 taper toward the bottom side 5 of the reaction frame 3, thereby preventing the sample cassette 19, or the cassette holder 20, from sliding downward (i.e. toward the bottom side 5) through the grooves 33 of the reaction frame 3. The locking mechanism thus enables the reaction frame 3 to be transferred quickly and safely from one receiving vessel 7 to another without the risk of loss of the sample cassette 19, or of the cassette holder 20. A receptacle profile 24 realized in such a manner thus has the advantage that the sample cassette 19, and the cassette holder 20, can be easily and reliably inserted into the receiver 24.

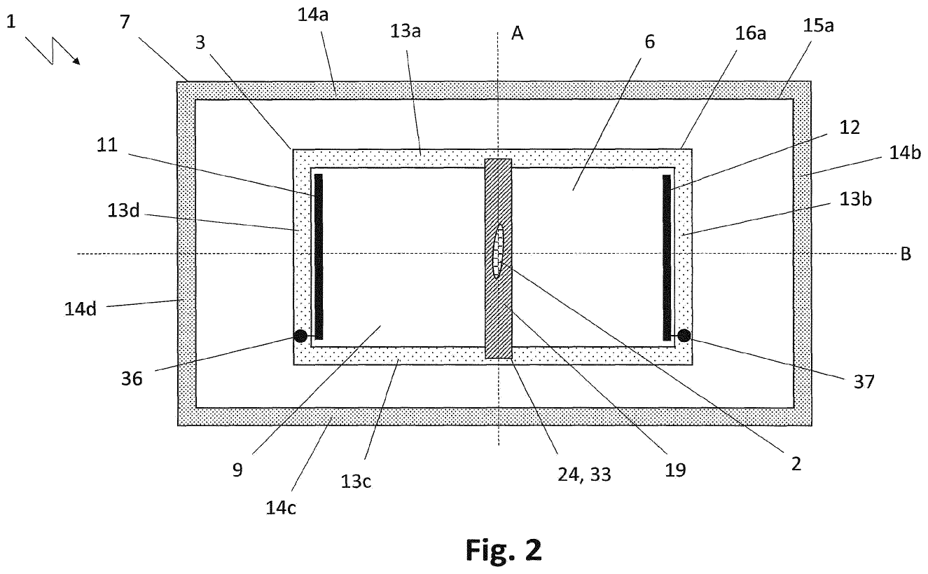

FIG. 2 shows an electrophoresis device 1 according to a horizontal embodiment with a sample cassette 19 and a receiving vessel 7, in a schematic plan view. The receiving vessel 7, which in the case of the horizontal embodiment is preferably a tank, has four outer side walls 14a-d which, together with a base plate 8 (FIG. 3), form a cuboid open toward the upper side. The upper side 4 of the frame 3 is understood to be the side that faces away from the base plate 8 of the tank 7. Correspondingly, the bottom side 5 of the reaction frame 3 is the side that faces toward the base plate 8 of the tank 7. The outer side walls 14a-d span an inner circumference 15a that is larger than the outer circumference 16a of the reaction frame 3, which is also cuboid-shaped. As a result, there is a distance between the outer side walls 14a-d of the tank 7 and the inner side walls 13a-d of the reaction frame 3. This distance should be large enough to allow the frame 3 to be inserted into and removed from the tank quickly and easily. Preferably, the distance should be at least 0.5 cm. When the tank 7 is filled with buffer 27, the reaction frame 3 and the bottom plate 8 form a reaction chamber 9 that is open on one side. The reaction frame 3 can then be removed from the receiving vessel 7 at any time and transferred to another receiving vessel 7 filled with fresh reaction liquid 27, without thereby transferring old reaction liquid 27. The reaction liquid 27 can then drain off through the opening 6 in the bottom side of the frame 3. This allows easy changing of the buffer. In particular, the device 1 does not have to be tipped.

The sample cassette 19 is inserted into the grooves 33 as shown in FIG. 2. In this case, when the sample cassette 19 is received in the grooves 33, the reaction chamber 9 is divided into a first reaction compartment 25 and a second reaction compartment 26. As a result, the biological sample 2 is arranged substantially centrally in the reaction chamber 9, where an approximately homogeneous electric field is concentrated between the electrodes 11, 12. The current flow in this case is from one of the electrodes 11, 12 (anode) to the other (cathode), and passes through the sample 2. In this way the contaminating components are removed from the sample 2, with negatively charged ions migrating to the anode, and positively charged ions to the cathode.

FIG. 3 shows the electrophoresis device 1 according to a horizontal embodiment with a receiving vessel 7 and a cover plate 10, in a longitudinal vertical cross-section. The sample cassette 19 in this case is clamped in a cassette holder 20, which in turn is received by the grooves 33. In order that the cassette holder 20, in which the sample cassette 19 is enclosed, can divide the reaction chamber 9 into two reaction compartments 25, 26, the cassette holder 20 is realized in such a manner that it protrudes above the surface of the reaction liquid 27 when it is received in the receiving profile 24 of the frame 3. This ensures that the current flowing between the electrodes 11, 12 during the electrophoretic clearing process passes exclusively through the tissue sample 2.

FIG. 3 further shows how the reaction frame 3 is received in the receiving vessel 7. It can be seen how the inner side walls 13a-d together with the base plate 8 form a reaction chamber 9, which in turn is divided into a first 25 and a second reaction compartment 26 when the cassette holder 20 is received in the grooves 33. In addition, a cover plate 10 is shown.

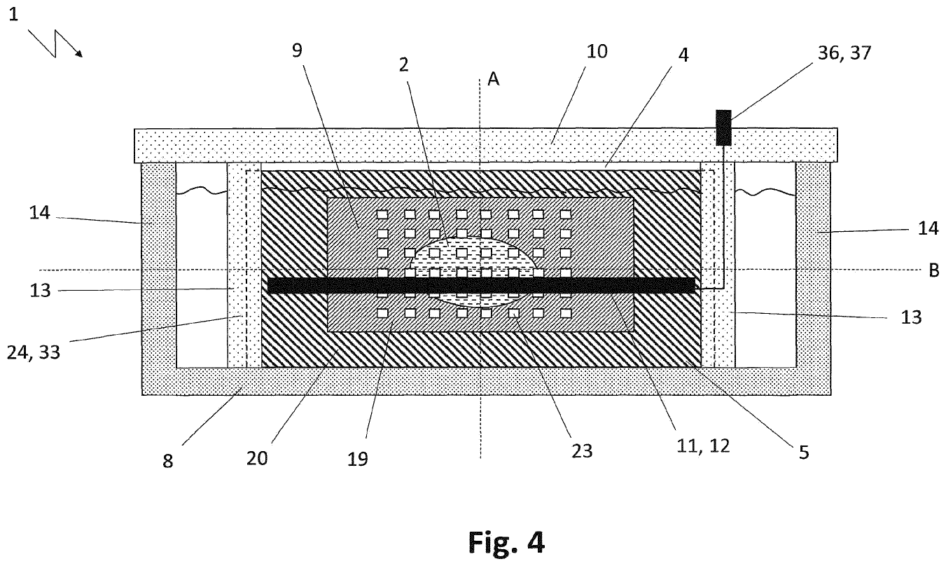

FIG. 4 shows an electrophoresis device 1 according to a horizontal embodiment with a receiving vessel 7 and a cover plate 10, in a transverse vertical cross-section.

According to the design shown, the first electrode 11 and the second electrode 12 are each realized in the form of a rod electrode. However, plate electrodes 11, 12 or electrodes 11, 12 realized as a grid may also be provided. Plate electrodes 11, 12 have the advantage that the electric field is evenly distributed over the entire reaction chamber 9 and is not just limited to a particular region within the reaction liquid 27. It is further advantageous if the first electrode 11 and the second electrode 12 are each in electrical contact with the power source via an electric leadthrough 36, 37. The electric leadthroughs 36, 37 make it particularly easy to connect the electrodes 11, 12 to a voltage device.

As can also be seen from FIG. 3 and FIG. 4, the device 1 shown has a cover plate 10 that can be attached to the top side 4 of the reaction frame 3. The cover 10 may, for example, be placed or plugged onto the frame 3. The cover 10 completely closes off the reaction frame 9 and the receiving vessel 7 such that no foreign bodies can enter the reaction chamber 9. This ensures a safe and clean clearing method. In particular in this case, it may be provided that at least one of the electric contacts for connecting the electric leadthroughs 36, 37 to a power source is recessed in the cover plate 10, such that the cover plate 10 needs to be attached to, or placed on, the reaction frame 3 in order to connect the device 10 to the power source. In this case, the electric contacts can simultaneously serve as plug connections for attaching the cover plate 10 to the reaction frame 3. This ensures that current can only flow in the reaction chamber 9 when the cover plate 10 closes the reaction frame 3, which serves as an additional safety aspect.

Additionally shown in FIG. 4 are the cassette holder 20 and the sample cassette 19, the sample cassette 19 being received in the cassette holder 20. For the exemplary embodiment, however, it is also conceivable for the sample cassette 19 to be inserted directly into the grooves 33 without the provision of an additional cassette holder 20. According to the design, it is provided that the cassette holder 20 is slid into the grooves 33 of the receiving profile 24, as a result of which the sample 2 is fixed in the center of the reaction frame 3 and thus in the electric field. The sample cassette 19 has perforations 23 configured in the form of a grid. The perforations 23 allow the buffer 27 to reach the tissue sample 2, such that the electric current removes the desired substances from the sample 2.

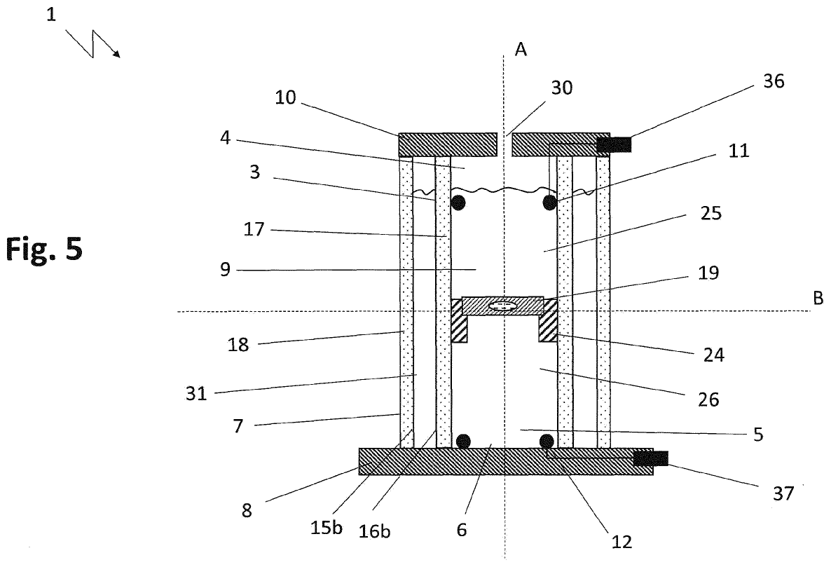

FIG. 5 shows an electrophoresis device 1 according to a vertical embodiment, in a vertical cross-section. In the case of this embodiment, the first electrode 11, the sample 2 and the second electrode 12 are arranged substantially vertically with respect to each other. The electrophoresis device 1 shown comprises a receiving vessel 7 with a base plate 8 and with an outer hollow cylinder 18 realized perpendicularly to the base plate 8, the outer hollow cylinder 18 being rotationally symmetrical about a vertical central axis A. The vertical electrophoresis apparatus 1 further comprises a reaction frame 3, which has an inner hollow cylinder 17 and a cover plate 10, the inner hollow cylinder 17 likewise being rotationally symmetrical about the vertical central axis A. In this case, the outer circumference 16b of the inner hollow cylinder 17 is smaller than the inner circumference 15b of the outer hollow cylinder 18. According to the embodiment shown, it is provided that an annular interspace 31 is realized between the inner hollow cylinder 17 and the outer hollow cylinder 18. This allows the frame 3 to be slid easily and smoothly into the receiving vessel 7.

A vertical electrophoresis device 1 according to FIG. 5 enables the sample cassette 19, together with the tissue sample 2, to be arranged horizontally, resulting in the reaction chamber 9 being divided into an upper first reaction compartment 25 and a lower second reaction compartment 26 when the cassette holder 20, or the sample cassette 19, is received in the electrophoresis device 1. For the purpose of receiving the cassette holder 20 or the sample cassette 19, the inner hollow cylinder 17 has a receiving profile 24 on its side that faces toward the reaction chamber 9, the receiving profile 24 being realized, according to the embodiment shown in FIG. 5, as an annular support for the sample cassette 19.

The design shown in FIG. 5 also allows easy buffer exchange: for this purpose, the reaction frame 3, comprising the inner hollow cylinder 17 and the cover plate 10, is removed together with the sample cassette 19 from the outer hollow cylinder 18 of the receiving vessel 7 and inserted into an outer hollow cylinder 18 of a second receiving vessel 7 filled with fresh buffer 27. The contaminated reaction liquid 27 can then drain off through the opened vent hole 28 and the opening 6 in the bottom side 5 of the cylindrical frame 3. To open the vent hole 28, it is necessary only to pull the vertical pin 29 out of the vent hole 28.

Alternatively, it is possible to fill the two reaction compartments 25, 26 separately, i.e. separately from each other, with reaction liquid 27. For this purpose, the cover plate 10 has a through-hole 30 for filling the upper reaction compartment 25 with reaction liquid 27. The through-hole 30 is centrally recessed in the cover plate 10 and realized in principle so to be closable. However, it should be open during the electrophoresis process so that the gas produced at the electrodes 11, 12 can escape. Preferably, the sample cassette 19 or the cassette holder 20 has a vent hole 28, so that the gas 34 produced at the lower electrode 12 (FIG. 5) can be discharged into the upper reaction compartment 25.

The first electrode 11 is attached to an end region of the inner hollow cylinder 17 near the top side 4, or the cover plate 10, namely on the side of the inner hollow cylinder 17 that faces toward the reaction chamber 9. According to FIG. 5, the second electrode 12 is attached substantially concentrically in the receiving vessel 7, on a side of the base plate 8 that faces toward the reaction chamber 9. According to the embodiment shown in FIG. 5, the first electrode 11 and the second electrode 12 are each of an annular shape. This ensures that the electric field is evenly distributed over the entire reaction chamber 9.

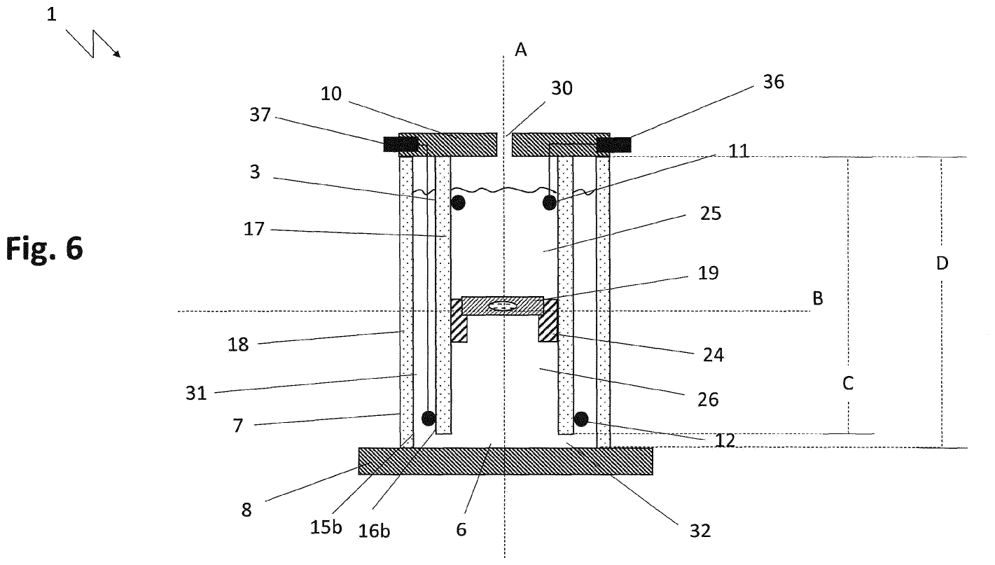

FIG. 6 shows an electrophoresis device 1 according to a further vertical embodiment with gap 32, in a vertical cross-section. The gap 32 is results from the inner hollow cylinder 17 being connected to the cover plate 10 and extending vertically toward the base plate 8, and the outer hollow cylinder 18 extending vertically from the base plate toward the cover plate 10, the inner hollow cylinder being of a first height C that is less than a second height D of the outer hollow cylinder 18. The embodiment shown in FIG. 6 differs from the embodiment according to FIG. 5 in that the second electrode 12 is attached, in the receiving vessel 7, on a side of the inner hollow cylinder 17 that faces away from the reaction chamber 9. In particular in this case, it is provided that the second electrode 12 is attached to the end of the inner hollow cylinder 17 on the base plate side, i.e. slightly above the gap 32. In order that the gas bubbles produced at the second electrode 12 during electrophoresis can escape from the electrophoresis device 1, the outer hollow cylinder 18 may have openings or perforations (not shown) in a region close to the cover plate 10, via which the gas bubbles can be released to the external environment. It is also conceivable for the cover plate 10 to rest only partially on the outer hollow cylinder 18, such that a small gap remains between the outer hollow cylinder 18 and the cover plate 10 when the cover plate 10 is attached to the inner hollow cylinder 18. Gas bubbles can then likewise escape through this upper gap. According to the embodiment shown in FIG. 6, the first electrode 11 and the second electrode 12 are each of an annular shape. Both electrical leadthroughs 36, 37 of this embodiment are arranged in the cover plate 10.

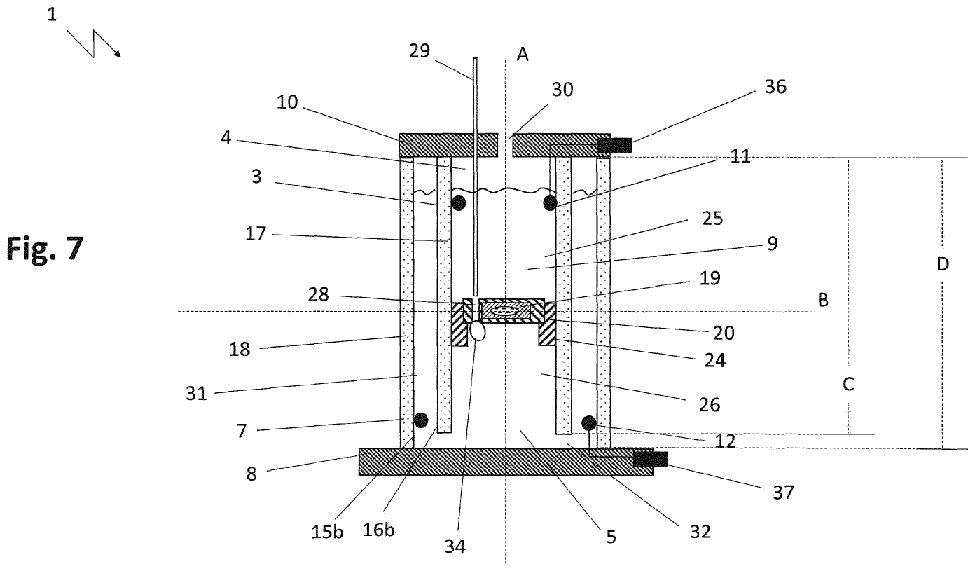

FIG. 7 shows an electrophoresis device 1 according to a further vertical embodiment, in a vertical cross-section. It differs from the electrophoresis device 1 shown in FIG. 6 only in that the second electrode 12 is attached to the inner side of the outer hollow cylinder 18. In this case, the inner side is the side that faces toward the inner hollow cylinder 17. The second electrode is also attached to the end of the outer hollow cylinder 18 on the base plate side, slightly above the gap 32. According to the embodiment shown in FIG. 7, the second electrical leadthrough 37 is arranged in the base plate 8.

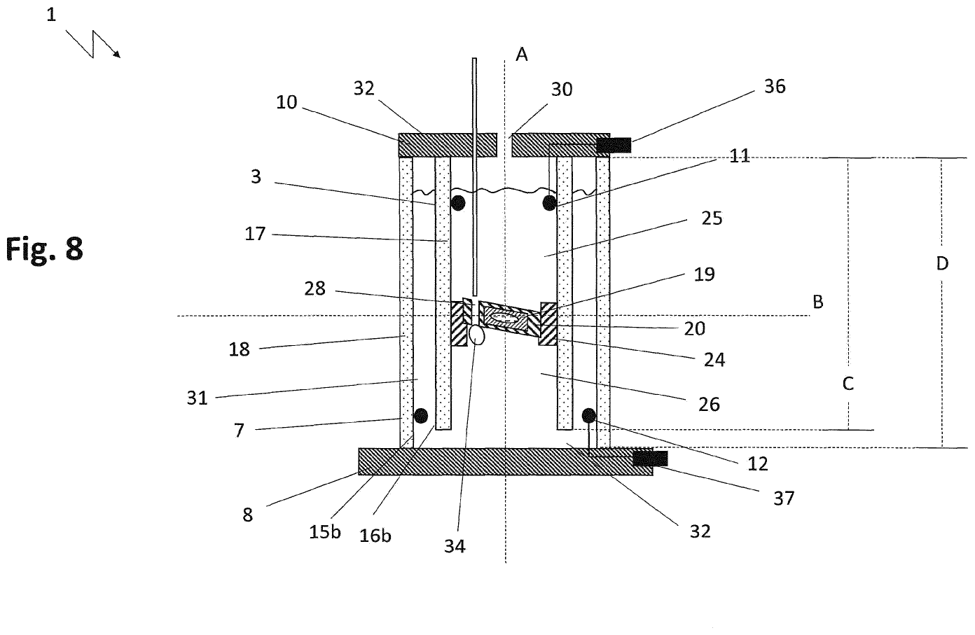

It is additionally provided that the cassette holder 20 has a vent hole 28 (FIG. 7 and FIG. 8) that connects the first reaction compartment 25 to the second reaction compartment 26. For the exemplary embodiment, however, it is also conceivable for the sample cassette 19 to be inserted directly into the receiving profile 24 without provision an additional cassette holder 20. In this case, the sample cassette 19 itself may have a vent hole 28. Furthermore, it is conceivable for the receiving profile 24 to have a vent hole 28. The vent hole 28 serves primarily to remove gas or air bubbles 34 produced during filling of the lower compartment 26 with buffer 27. The vent hole 28 then allows these bubbles 34 to pass through so that they can reach the surface of the reaction liquid 27 unhindered. In addition, a vertical pin 29 is provided for closing and opening the vent hole 28, the vertical pin 29 passing through a corresponding hole in the cover plate 10 so that it can be operated from outside the reaction chamber 9. During the electrophoresis process, the vertical pin 29 closes the vent hole 28 so that no current can flow past the sample 2 through the vent hole 28.

FIG. 8 shows an electrophoresis device 1 according to a further vertical embodiment, in a vertical cross-section. In contrast to the embodiment shown in FIG. 7, according to the electrophoresis device in FIG. 8 it is provided that the receiving profile 24 receives the sample cassette 19, or the cassette holder 20, at an inclination relative to the horizontal central axis B. The vent hole 28 in this case is realized at the highest point of the cassette holder 20, the highest point being understood to be that region of the cassette holder 20 that is closest to the surface of the reaction liquid 27. Advantageously, the gas bubbles 34 produced when the lower reaction chamber 26 is filled with buffer 27 collect in the vicinity of the vent hole 28, through which they can be discharged toward the surface of the reaction liquid 27.

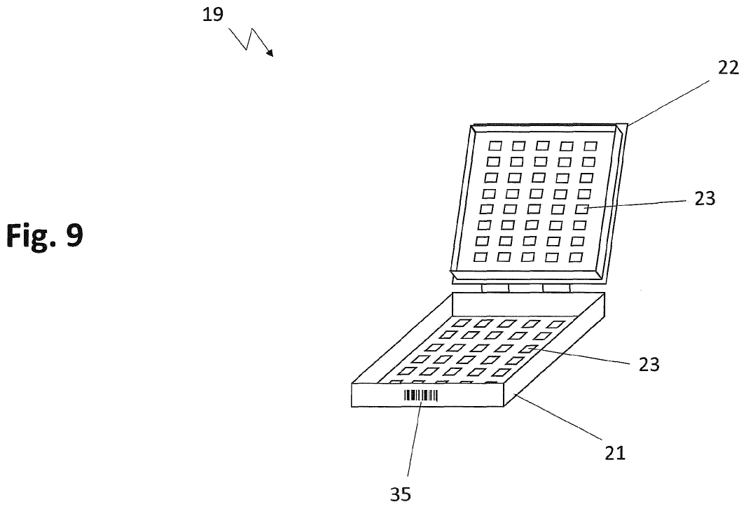

FIG. 9 shows a preferred embodiment of the sample cassette 19. The sample cassette 19 comprises a base element 21 and a cover element 22 that can be folded together by means of hinges to form a cassette enclosing the sample 2. According to the preferred embodiment shown, it is provided that the sample cassette 19 is perforated, at least in sections, in particular the base element 21 and the cover element 22 each having a multiplicity of perforations 23 arranged in a grid-like manner. The perforations 23 allow the reaction liquid 27 to reach the tissue sample 2, which in turn ensures that the electric current removes the desired substances from the sample 2. To facilitate the assignment of different samples 2, it is also provided that the sample cassettes 19 have a bar code 35 by which they can be identified. Finally, it may be provided that the sample cassette 19 is produced from a chemically inert and electrically insulating material, in which case polyoxymethylene may preferably be used as the insulating material.

The invention is not limited to any of the above-described embodiments, but may be varied in a variety of ways.

All of the features and advantages, including constructional details, spatial arrangements and method steps given by the claims, the description and the drawing, can be essential to the invention both individually and in the widest variety of combinations.

1. An electrophoresis device for use in a method for producing transparent biological samples, comprising a reaction frame, wherein the reaction frame has an open top side and a bottom side opposite the top side, wherein the bottom side at least partially comprises an opening.

2. The electrophoresis device as claimed in claim 1, wherein the reaction frame can be inserted into a receiving vessel, wherein the receiving vessel has a base plate, and wherein the reaction frame realizes, with the receiving vessel, a reaction chamber.

3. The electrophoresis device as claimed in claim 1, wherein the reaction frame has a cover plate, which is fixedly or detachably connected to the top side of the reaction frame, wherein the cover plate substantially completely covers the top side of the reaction frame.

4. The electrophoresis device as claimed in claim 1, wherein the electrophoresis device has a first electrode and a second electrode.

5. The electrophoresis device as claimed in claim 1, wherein the reaction frame comprises four inner side walls, which are arranged in a cuboid shape in relation to one another.

6. The electrophoresis device as claimed in claim 4, wherein the receiving vessel has four outer side walls, which are arrange in a cuboid shape in relation to one another, wherein the four outer side walls have an inner circumference that is larger than an outer circumference of the inner side walls.

7. The electrophoresis device as claimed in claim 1, wherein the reaction frame comprises an inner hollow cylinder.

8. The electrophoresis device as claimed in claim 7, wherein the receiving vessel comprises an outer hollow cylinder, wherein the outer hollow cylinder has an inner circumference that is larger than an outer circumference of the inner hollow cylinder.

9. The electrophoresis device as claimed in claim 5, wherein the first electrode is arranged, on the reaction chamber side, on one of the inner side walls, and that the second electrode is arranged, on the reaction chamber side, on the inner side wall that is opposite the first electrode.

10. The electrophoresis device as claimed in claim 7, wherein that the first electrode is arranged, on the reaction chamber side, on the inner hollow cylinder.

11. The electrophoresis device as claimed in claim 1, wherein the electrophoresis device has a sample cassette.

12. The electrophoresis device as claimed in claim 11, wherein the electrophoresis device comprises a cassette holder, into which the sample cassette can be clamped.

13. The electrophoresis device as claimed in claim 11, wherein the sample cassette comprises a base element and a cover element, which can be plugged together to form a cassette enclosing the sample, wherein the base element and the cover element each have a multiplicity of perforations arranged in a grid-like manner.

14. The electrophoresis device as claimed in claim 11, wherein the reaction frame has a receiving profile for receiving the sample cassette or for receiving the cassette holder.

15. The electrophoresis device as claimed in claim 11, wherein the reaction chamber is divided into a first reaction compartment and a second reaction compartment when the sample cassette or the cassette holder is received in the receiving profile.

16. A use of a sample cassette as claimed in claim 11 for an electrophoresis method.

17. The use of a sample cassette as claimed in claim 16, wherein the electrophoresis method is an electrophoresis method for producing transparent biological samples.
